(19) United States
(12) Patent Application Publication
(10) Pub. No.: US 2022/0016792 A1
(43) Pub. Date: Jan. 20, 2022

(54) COMB ATTACHMENT AND HAIR CUTTING APPLIANCE

(71) Applicant: KONINKLIJKE PHILIPS N.V., EINDHOVEN (NL)

(72) Inventors: Luca IACCARINO, GRONINGEN (NL); Theodoor René Maria HIN, EMMEN (NL)

(21) Appl. No.: 17/311,804

(22) PCT Filed: Jan. 16, 2020
(86) PCT No.: PCT/EP2020/050977

§ 371 Date: Jun. 8, 2021

(30) Foreign Application Priority Data
Jan. 23, 2019 (EP) 19153214.2

(51) Int. Cl. B26B 19/20; B26B 19/38

(52) U.S. Cl. CPC B26B 19/20; B26B 19/3813

(57) ABSTRACT

The present disclosure relates to a comb attachment (130) for a hair cutting appliance (100) as well as a hair cutting appliance (100). The comb attachment (130) comprises: a frame portion (131) enclosing a cutting area (A) that is adapted to at least partially receive a cutting unit (120) of the hair cutting appliance (100), an attachment means (132) extending from the frame portion (131) away from the cutting area (A), the attachment means (132) having at least one attachment point adapted to attach the comb attachment (130) to the hair cutting appliance (100), a sidewall (133) extending from the frame portion (131) in a common direction with the attachment means (132), a set of first teeth (134) at least partially extending along the cutting area (A) from the frame portion (131) in a first teeth extending direction that at least partially corresponds to a cutting direction (C) during hair cutting, the first teeth (134) are spaced from each other in a teeth spacing direction that is perpendicular to the first teeth extending direction, thereby forming a respective gap (G) between the individual first teeth (134), a gap cover (135) extending in sections from the sidewall (133) and adapted to cover the respective gap (G) of the first teeth (134), the sidewall (133) and the gap cover (135) forming an enclosed space (136) adapted to at least temporarily collect cut hair debris during hair cutting, wherein the sidewall (133) extends over a height that overlaps with the at least one attachment point of the attachment means (132), the at least one attachment point being arranged so that the sidewall (133) overlaps with a section of the hair cutting appliance (100) when the comb attachment (130) is attached thereto via the attachment means (132), and wherein the gap cover (135) and the sidewall (133), with respect to the cutting direction (C), are arranged at a rear of the frame portion (131).

### FIELD OF THE INVENTION

The present invention relates to hair cutting appliances. In particular, a comb attachment for attaching to a hair cutting appliance is discussed, as well as a hair cutting appliance comprising a comb attachment that is releasable attachable to the hair cutting appliance.

### BACKGROUND OF THE INVENTION

Hair cutting appliances are generally known as means for hair cutting, hair trimming, shaving, or the like. Accordingly, such a hair cutting appliance may be provided, for example, as a hair trimmer, a hair clipper, a shaver etc. Besides purely mechanical hair cutting appliances, there are also hair cutting appliances that are electrically powered or driven, respectively. When using such a hair cutting appliance, hair collection during and/or after hair cutting may be an important issue. Typically, when hair is trimmed or shaved, the cut hair pieces, which may also referred to as hair debris, fall from the direct hair cutting site in various directions, e.g. on a surrounding floor, on clothes of a subject, e.g. a human person, who subject is cut the hair. Thereby, the hair debris may even adhere to the subject, e.g. to its clothes or skin. Accordingly, falling and/or spreading hair debris may require additional cleaning measures, such as floor cleaning, hair washing, brushing of clothes, or the like.

US 2010/0011586 A1 discusses a hair trimming unit comprising a plastic housing that is configured with a finger pad against which a finger of a user can be applied for pivoting the trimming unit to open up an upper side with respect to a handle to facilitate the removal of cut hairs that may collect on the trimming unit above the blade.

### SUMMARY OF THE INVENTION

There is, therefore, a need to improve a comb attachment applicable to collect hair cut pieces during hair cutting. The object of the present invention is solved by the subject-matter of the appended independent claims, wherein further embodiments are incorporated in the dependent claims.

According to a first aspect, there is provided a comb attachment for a hair cutting appliance. The comb attachment comprises:

a frame portion enclosing a cutting area that is adapted to at least partially receive a cutting unit of the hair cutting appliance,

an attachment means extending from the frame portion away from the cutting area, the attachment means having at least one attachment point adapted to attach the comb attachment to the hair cutting appliance,

a sidewall extending from the frame portion in a common direction with the attachment means,

a set of first teeth at least partially extending along the cutting area from the frame portion in a first teeth extending direction that at least partially corresponds to a cutting direction during hair cutting, the first teeth are spaced from each other in a teeth spacing direction that is perpendicular to the first teeth extending direction, thereby forming a respective gap between the individual first teeth,

a gap cover extending in sections from the sidewall and adapted to cover the respective gap of the first teeth, the sidewall and the gap cover forming an enclosed space adapted to at least temporarily collect cut hair debris during hair cutting,

wherein the sidewall extends over a height that overlaps with at least one attachment point of the attachment means, at least one attachment point being arranged so that the sidewall overlaps with a section of the hair cutting appliance when the comb attachment is attached thereto via the attachment means, and

wherein the gap cover and the sidewall, with respect to the first teeth extending direction, are arranged at a rear of the frame portion.

Optionally, the gap cover may be provided as a filling material extending over a partial thickness or entire thickness of the first teeth, wherein the filling material is arranged between the individual teeth, or as a sheet covering the first teeth on at least one side thereof, wherein the side may face the cutting area or facing away therefrom to a skin surface of a subject which wants to cut his hair, etc.

An effect of this comb attachment is that the first teeth, and in particular the gaps there between, are at least closed and/or covered in sections, with respect to the cutting direction at a rear side of the comb attachment and/or its frame portion. Further, in an operating condition in which the comb attachment is attached to the hair cutting appliance, a further gap between the comb attachment and the hair cutting appliance or a section of the same, respectively, is bridged or closed by the sidewall. The gap cover and the sidewall, with respect to the first teeth extending direction, may be arranged at a rear of the frame portion. The first teeth extending direction at least largely corresponds to the cutting direction or a guiding direction of the comb and/or the hair cutting appliance during hair cutting, so that the enclosed space is adapted to collect the cut hair debris at a rear side of the comb and/or its frame portion. By at least closing the teeth or the gaps there between, respectively, in sections, as well as by bridging or closing the further gap between the comb attachment and the hair cutting appliance the resulting enclosed space may be used as a rear collection chamber that is adapted to collect the cut hair pieces or hair debris, respectively. In the following, cut hair pieces and hair debris may commonly be referred to as the hair debris. Also, in the following, the enclosed space may be referred to as the collection chamber, in particular as the rear collection chamber. At the comb attachment, the gap cover and/or the first teeth may have a shovel-like function to collect the hair debris in the rear collection chamber. Thus, during hair cutting, the hair debris may be pushed towards the rear of the comb and may be collected in the rear collection chamber. Hence, the performance of the comb as well as the hair cutting appliance may particularly be improved in terms of the cut hair debris falling out from the comb attachment.

According to an embodiment, the sidewall encloses a plane lying in the cutting area by more than 90°. The frame portion may have various cross-sectional shapes, such as rectangular, oval, etc., wherein the sidewall may extend along a circumference of the cross-sectional shape so far that, as in a rectangular cross-section, not only one side, but two or more sides of the cutting area are surrounded by the sidewall. Similarly, at e.g. an oval cross-sectional shape of the frame portion surrounding the cutting area the sidewall may extend along an arc portion which is more than 90°. Thus, a volume of the rear collection chamber may be increased, and falling out of hair debris on a lateral side, with respect to the cutting direction, may be prevented.

In another embodiment, the gap cover and the first teeth, in the section of the enclosed space, may be integrally molded. In other words, the first teeth and the gap cover may form an integral one-piece part. The comb attachment may, for example, be manufactured by injection molding using a suitable plastic material. Thus, the comb attachment may be particularly easy manufactured, and may be easily handled as there are no loose parts for forming the rear collection chamber.

Alternatively, the gap cover may be provided as a separate part. It may be adapted to be optionally attached to an existing comb attachment. In this case, the gap cover may be integrally formed with the sidewall, wherein both the gap cover and the sidewall be adapted to be optionally attached to an existing comb attachment.

In an embodiment, the gap cover may comprise a first gap cover (portion) adapted to cover the respective gap, with respect to the cutting area, from a first a side of the first teeth and a second gap cover (portion) adapted to cover the respective gap, with respect to the cutting area, from a second side of the first teeth, the second side opposing the first side. It is noted that the first and second gap cover are not necessarily provided as separate part. Rather, in at least some embodiments, the gap cover may be designed differently on the different sides of the first teeth in terms of its dimensions, thickness, length, etc.

According to an embodiment, the first teeth may have a free end on a side spaced from the rear of the frame portion. It is noted that the rear of the frame portion may refer to the first teeth extending direction that at least largely corresponds to the cutting direction or a guiding direction of the comb and/or the hair cutting appliance during hair cutting. In this context, a free end may be understood in a way that the first teeth are hinged only on one of two opposing sides, and that the free end is not hinged to another component, such as the frame portion. Thus, the first teeth, individually or commonly, may move freely at least within limits, which limits may be determined by e.g. the elasticity of the material used for manufacturing of the first teeth, a length of extension of the gap cover etc.

According to another embodiment, an end of the gap cover spaced from the rear of the frame portion may comprise a chamfer. The end of the gap cover or the chamfer, respectively, may be arranged at an entrance of the collection chamber, which entrance is arranged away from the rear of the frame portion in the first teeth extending direction, to work shovel-like.

In an embodiment, the chamfer may at least substantially be flush with a sliding surface of the first teeth, the sliding surface facing away from the cutting area and adapted to have skin contact during hair cutting. In other words, the sliding surface may, with respect to the cutting area and/or the collection chamber, be arranged at an outer side of the comb attachment. Therefore, the gap cover and thus the entrance of the collection chamber may cling even closer to the skin of a subject and transport the hair debris particularly efficiently into the rear collection chamber.

According to an embodiment, the first teeth, from the rear of the frame portion, may extend over a first length and the gap cover, from the rear of the frame portion, may extend over a second length shorter than the first length. In other words, the gap cover preferably extends only over a partial section of the first teeth extending direction and not over the entire length thereof. This allows a good collection of the hair debris and still ensures good movability, e.g. swinging, of the first teeth, both mutually as well as in common relative to the sidewall and/or the frame portion.

In another embodiment, the attachment means may comprise a plurality of attachment points, each of which is assigned to an individual attachment position with respect to the hair cutting appliance. The attachment points may be spaced from each other with respect to an attachment direction. The sidewall may extend over a height that overlaps with each one of the plurality of attachment points and with a section of the hair cutting appliance when the comb attachment may be attached thereto via the attachment means. In other words, the comb attachment may be configured as a so-called spacing comb adapted to set a desired cutting length during hair cutting. Accordingly, the cutting length may be set to a fixed value, each of which is assigned to one attachment point of the plurality attachment points. For example, such an attachment point by be assigned to the cutting length of 6° mm (millimeter), 9 mm, 10 mm, 12 mm etc. The comb attachment may be adjustable to at least two different attachment points, e.g. by a translational or sliding movement along a longitudinal axis of the hair cutting appliance, wherein that longitudinal axis may correspond to the attachment direction of the comb attachment. For example, an outer edge of the sidewall, which outer edge may be arranged on an outer side with respect to the cutting area from which it faces away, may overlap with the hair cutting appliance, e.g. with a housing thereof, in each attachment position defined by the individual attachment points assigned to the desired cutting length. Thus, the collection chamber is consistently closed with respect to the hair cutting appliance, so that the hair debris is collected therein reliable and independently from the set cutting length.

According to an embodiment, the comb attachment may further comprise a set of second teeth at least partially extending along the cutting area from the frame portion towards the rear of the frame portion, wherein a free end of the second teeth is spaced from a free end of the first teeth. Thus, the hair to be cut may be set up towards the cutting unit of the hair cutting appliance. Additionally or alternatively, the second teeth may support directing hair debris to the entrance of the rear collection chamber.

Optionally, the first teeth and second teeth may be arranged at an angle to each other. Thereby, during hair cutting, the second teeth may be brought into contact with the skin and/or hair of the subject first, before the first teeth are brought into contact therewith. Accordingly, the second teeth may work as a guidance to set up the hair towards the cutting unit of the hair cutting appliance. Consequently, in a typical attitude of the hair cutting appliance during hair cutting, the cut hair debris may fall in the collection chamber and/or may be caught in the collection chamber when the hair debris fall due to gravity.

In a second aspect, a hair cutting appliance is provided. The hair cutting appliance comprises:

a housing;

a cutting unit comprising at least one cutting element extending in a cutting direction; and

a comb attachment adapted to be releasable attachable or attached to the housing. The comb attachment comprises:

a frame portion enclosing a cutting area that is adapted to at least partially receive a cutting unit of the hair cutting appliance,

an attachment means extending from the frame portion away from the cutting area, the attachment means having at least one attachment point adapted to attach the comb attachment to the hair cutting appliance,

a sidewall extending from the frame portion in a common direction with the attachment means,

a set of first teeth at least partially extending along the cutting area from the frame portion in a first teeth extending direction that at least partially corresponds to a cutting direction during hair cutting, the first teeth are spaced from each other in a teeth spacing direction that is perpendicular to the first teeth extending direction, thereby forming a respective gap between the individual first teeth,

a gap cover extending in sections from the sidewall and adapted to cover the respective gap of the first teeth, the sidewall and the gap cover forming an enclosed space adapted to at least temporarily collect cut hair debris during hair cutting,

wherein the sidewall extends over a height that overlaps with the at least one attachment point of the attachment means, the at least one attachment point being arranged so that the sidewall overlaps with a section of the hair cutting appliance when the comb attachment is attached thereto via the attachment means, and

wherein the gap cover and the sidewall, with respect to the first teeth extending direction, are arranged at a rear of the frame portion.

An effect of this hair cutting appliance is that a collection chamber is formed, with respect to the cutting direction, at a rear side of the comb attachment. Therefore, hair debris that arises during hair cutting may be effectively collected in the collection chamber, and thus the hair debris is prevented from falling down from a hair cutting site. Due to the overlap between the sidewall of the comb attachment and the housing of the hair cutting appliance, the collection chamber is at least substantially closed to the outside.

Generally, the hair cutting appliance may be suitable for both professional use and home use. Further, the hair cutting appliance may be adapted to shave and/or trim body hair, such as facial hair and head hair. Also, the hair cutting appliance may be provided as an electric hair cutting appliance, electrically powered by e.g. a wired electric supply means and/or by an energy storage. Accordingly, the cutting unit may comprise an electric motor that is powered electrically. Preferably, the hair cutting appliance is adapted to optionally lock and unlock the comb attachment in different attachment positions that may be set by attachment points. These attachment points may be assigned to the corresponding attachment positions to provide an adjustable spacing comb, allowing to set a desired hair cutting length, such as 6 mm, 8 mm, 9 mm, 10 mm, 12 mm etc. Therefore, the attachment means of the comb attachment may comprise a form-locking and/or force-locking attachment means, such as a snap-lock or the like. Likewise, the housing of the hair cutting appliance may comprise a counter attachment means that is adapted to interact with the attachment means of the comb attachment. The housing may be made from a suitable plastic material or the like, allowing to form the counter attachment means.

In an embodiment, the enclosed space, which may be referred to as the rear collection chamber may, with respect to the cutting direction, be arranged behind a cutting edge of the cutting element. Accordingly, the collection chamber may be arranged at the rear side of the comb attachment so that an edge or the like of the gap cover and/or the first teeth may collect the cut hair debris shovel-like. As a result, in particular during hair cutting, the cut hair debris may be pushed to the rear side of the comb attachment and may be collected in the closed rear collection chamber formed at the rear side of the comb attachment and/or its frame portion.

According to an embodiment, the gap cover of the comb attachment extends from rear of the frame portion over a length shorter than a cutting element extending length in the cutting direction. Thus, a shovel-like entrance of the rear collection chamber is arranged behind the cutting element or its cutting edge, so that the cut hair debris is effectively transported into the collection chamber.

In an embodiment, the gap cover of the comb attachment at least in sections extends in parallel to the cutting element. In a typical attitude of the hair cutting appliance during hair cutting, the cut hair debris may fall in the collection chamber and/or may be caught in the collection chamber when the hair debris fall due to gravity.

According to an embodiment, the enclosed space is further enclosed by the housing and/or the cutting unit. Thus, the resulting collection chamber may be fully closed to the outside, so that the cut hair debris may particularly reliable collected therein.

In an embodiment, the sidewall of the comb attachment overlaps with a section of the hair cutting appliance, in particular its housing, when attached thereto via the attachment means. Overlapping of the sidewall with the section of the hair cutting appliance may be provided for each single attachment point of the attachment means or the counter attachment means, respectively. Thus, the resulting rear collection chamber may be fully closed to the outside, so that the cut hair debris may particularly reliable collected therein.

These and other aspects of the present invention will become apparent from and elucidated with reference to the embodiments described hereinafter.

### BRIEF DESCRIPTION OF THE DRAWINGS

Exemplary embodiments of the invention will be described in the following with reference to the following schematic drawings:

FIG. 1 shows a perspective view of a hair cutting appliance with an attached comb attachment according to an exemplary embodiment of the invention.

FIG. 2 shows a perspective top view of a comb attachment according to an exemplary embodiment of the invention.

FIG. 3 shows a perspective bottom view of a comb attachment according to an exemplary embodiment of the invention.

FIG. 4 shows a perspective sectional view of a comb attachment according to an exemplary embodiment of the invention.

FIG. 5 shows a perspective section view of a hair cutting appliance with an attached comb attachment according to an exemplary embodiment of the invention.

### DETAILED DESCRIPTION OF THE EMBODIMENTS

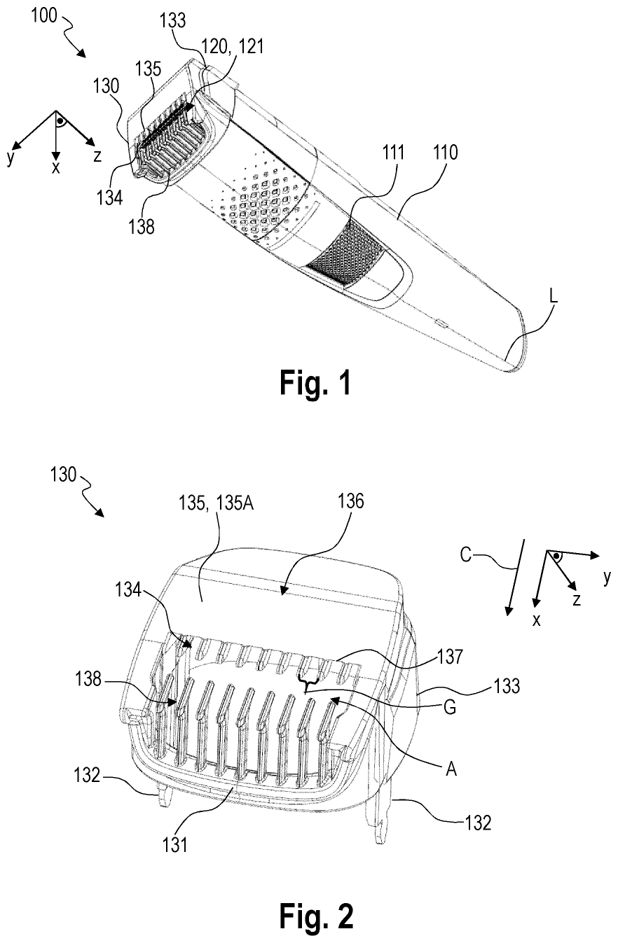

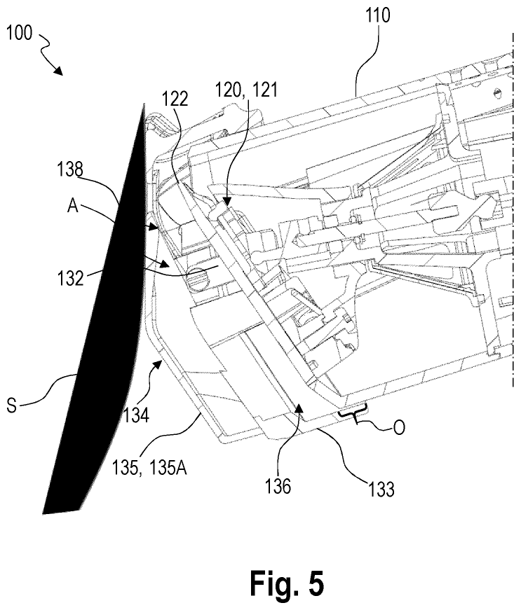

FIG. 1 schematically shows in a perspective view an exemplary hair cutting appliance 100, which may, in at least some embodiments, be provided as a hair clipper or the like. In particular, FIG. 1 shows the hair cutting appliance 100 in an operating condition, which may allow hair trimming, namely cutting hair to a desired length. The hair cutting appliance 100 comprises a housing 110, which may be formed from a suitable plastic material. In at least some embodiments, the housing 110 accommodates an electric motor and/or a drive mechanism (which in FIG. 1 are not specifically designated; however, see e.g. FIG. 5 for a general understanding of that arrangement within the housing 110). The electric motor may be electrically powered by an electric power supply, such as an electrical energy storage, e.g. a replaceable or rechargeable battery, and/or an electrical power connection via a wired electric supply means. To turn on and off the electrical power, the housing 110 comprises a switching means 111 that is electrically connected to the electric motor and/or the electric power supply.

Further, at one longitudinal end, the hair cutting appliance 110 comprises a cutting unit 120 having at least one cutting element 121, such as one or more movable blades, which is in at least some embodiments, driven by the electric motor via the drive mechanism to enable a cutting motion. The cutting element 121, or each of the one or more blades, may comprise a cutting edge 122. It is noted that in FIG. 1 the cutting unit 120 and the cutting element 121 are partially covered by a comb attachment 130 which is described in more detail below, so that the arrangement of the cutting unit 120 and/or cutting element 121 may be best seen in FIG. 5. In some embodiments, the comb attachment 130 may be releasable attachable to the hair cutting appliance 100.

Still referring to FIG. 1 it is noted that a Cartesian coordinate system X-Y-Z with an X-axis, a Y-axis and a Z-axis is used in some of the drawings for better illustration and for indicating specific directions of extension or the like. As used hereinafter, the Z-axis may correspond to or may be aligned with a longitudinal axis L of the hair cutting appliance 100, so that the Z-axis may correspond to a length extension of the cutting appliance 100. The X-axis may be used as a reference for a cutting direction during hair cutting with the hair cutting appliance 100 being guided along the X-axis during hair cutting. The Y-axis may correspond to a width extension of the cutting appliance 100, in particular to the width in the area of the comb attachment 130. Accordingly, when referring hereinafter to a rear, a rear side or a rear portion of the comb attachment 130 with respect to the cutting direction, it may be understood that a corresponding cutting direction C may at least substantially be aligned with the X-axis. Thereby, with respect to the Cartesian coordinated system X-Y-Z of FIG. 1, said rear, rear side or rear portion faces away from the arrowhead of the shown X-axis.

As shown in FIG. 1, the comb attachment 130 is attached to the longitudinal end of the housing 110 of the hair cutting appliance 100 at which the cutting unit 120 is arranged, so that the comb attachment 130 at least partially receives the cutting unit 120 and/or cutting element 121. Functionally, the cutting element 121 moves inside the comb attachment 130, wherein a plane spanned by X-Y of the Cartesian coordinate system defines a cutting area A into which hair protrudes to be cut. Generally, the comb attachment 130, when attached to the housing 110, spaces the cutting element 121 from a skin surface of a subject S (see FIG. 5), e.g. a human person, who wants to cut his hair. As it will be described in more detail below, the comb attachment 130 is adjustable relative to the housing 110, namely along the longitudinal axis L of the hair cutting appliance 100, which means along the Z-axis of FIG. 1, through a translational or sliding movement. By moving the comb attachment 130 along the longitudinal axis L or Z-axis, respectively, the spacing between the skin surface of the subject S and the cutting element 121 may be adjusted to obtain a desired length of the remaining hair. To attach the comb attachment 130 to the hair cutting appliance 100, the housing 110 comprises counter attachment means 112, which may further be adapted to provide a longitudinal guidance for guided adjusting the spacing or desired length of the remaining hair, respectively, and to allow fixing the comb attachment 130 relatively to the housing 110 at a specific attachment point assigned to that adjustment. Fixing of the comb attachment 130 to the housing 110 can be done in a form-locking and/or force-locking manner.

FIG. 2 schematically shows a perspective top view of the comb attachment 130. In at least some embodiments, the comb attachment 130 may be manufactured by injection molding using a suitable plastic material, and may be provided as an integral one-piece part.

The comb attachment 130 comprises a frame portion 131, which, in at least some embodiments, may have a circumferentially closed cross-section, e.g. with a rectangular shape, oval shape etc. By way of example, in FIG. 2, the frame portion 131 has an approximately rectangular cross-section with rounded corners. Referring to the Cartesian coordinate system X-Y-Z, the plane spanned by X-Y corresponds to or lies in the cutting area A as described above. This means that, if the comb attachment 130 is attached to the hair cutting appliance 100, the cutting unit 120 and/or cutting element 121 is at least partially disposed within the frame portion 131. As mentioned above, the X-axis as shown in FIG. 2 (as well as in FIG. 1), along which the hair cutting appliance 100 is moved during hair cutting, is aligned with the cutting direction C which is also shown in FIG. 2 for better understanding.

From the frame portion 131, an attachment means 132 extends away along the Z-axis or longitudinal axis L of the hair cutting appliance 100, respectively. By way of example, the comb attachment 130 comprises two attachment means 132, one on each lateral side of the frame portion 131 with respect to the cutting direction C or the X-axis, respectively. The respective attachment means 132 is formed as a beam, designed and dimensioned to fit the counter attachment means 112 of the housing 110. The attachment means 132 and/or the counter attachment means 112 comprises one or more attachment points which are arranged distributed along the Z-axis and which are associated with a desired length of the remaining hair, e.g. to 6° mm, 8° mm, 9° mm, 10° mm, 12° mm etc.

Further, from the frame portion 131, a sidewall 133 extends in terms of its height extension in a substantially common direction with the attachment means 132, namely along the Z-axis. Dimensionally, the sidewall 133 extends over a height that overlaps with each of the attachment points arranged along the respective beam of the attachment means 132, so that in the operating condition of the hair cutting appliance 100 as shown in FIG. 1, in which the comb attachment 130 is attached to the longitudinal end of the cutting appliance 100 via the attachment means 132, the sidewall 133 always overlaps with a section of the hair cutting appliance 100, in particular with its housing 110. Therefore, regardless of the set attachment point at which the comb attachment 130 is attached and/or fixed to the housing 100, there is no gap or opening between the housing 100 and the sidewall 133 of the comb attachment 130.

As shown in FIG. 2, the sidewall 133 is, with respect to the cutting direction C along the X-axis, mainly arranged at the rear of the comb attachment 130, so that cut hair debris may be caught by an inner side of the sidewall 133, namely the side facing the cutting area A, if the comb attachment 130 and/or the hair cutting appliance 100 is moved in that direction along the X-axis. However, in at least some embodiments, the sidewall 133 extends along with the frame portion 131 that encloses the plane spanned by X-Y lying in the cutting area A by a length that extends to one or more lateral sides of the frame portion 131 with respect to the X-Axis. In embodiments in which the frame portion 131 may comprises rounded corners or the like, said extension length of the sidewall 133 along the frame portion 131 may be understood that it encloses the plane spanned by X-Y lying in the cutting area A by more than 90°. By way of example, in FIG. 2, the sidewall 133 substantially surrounds the cutting area A or the plane spanned by X-Y, respectively, completely, wherein in a length section of about 100° to 180° (or more) at the rear of the comb attachment 130 the height extension of the sidewall 133 is greater than in the remaining length sections.

As further shown in FIG. 2, the comb attachment 130 further comprises a set of first teeth 134 which at least partially extend along the cutting area A from one side of the frame portion 131 in a first teeth extending direction that at least partially corresponds to the cutting direction C during hair cutting. In other words, the first teeth 134 at least partially complete the cutting area A to the outside. In the width extension of the comb attachment 130, namely along the Y-axis as shown in FIG. 2 (or in FIG. 1), the first teeth 134 are spaced from each other in a teeth spacing direction that is substantially perpendicular to the first teeth extending direction or the cutting direction C, respectively, thereby forming a respective gap G between the individual first teeth 134. The first teeth 134 may be arranged distributed in plurality over the entire width (when referring to the Cartesian X-Y-Z coordinate system along the Y-axis) of the frame portion 131. As mentioned above, the first teeth 134 may be formed from the same plastic material as the frame portion 131 and/or the sidewall 133.

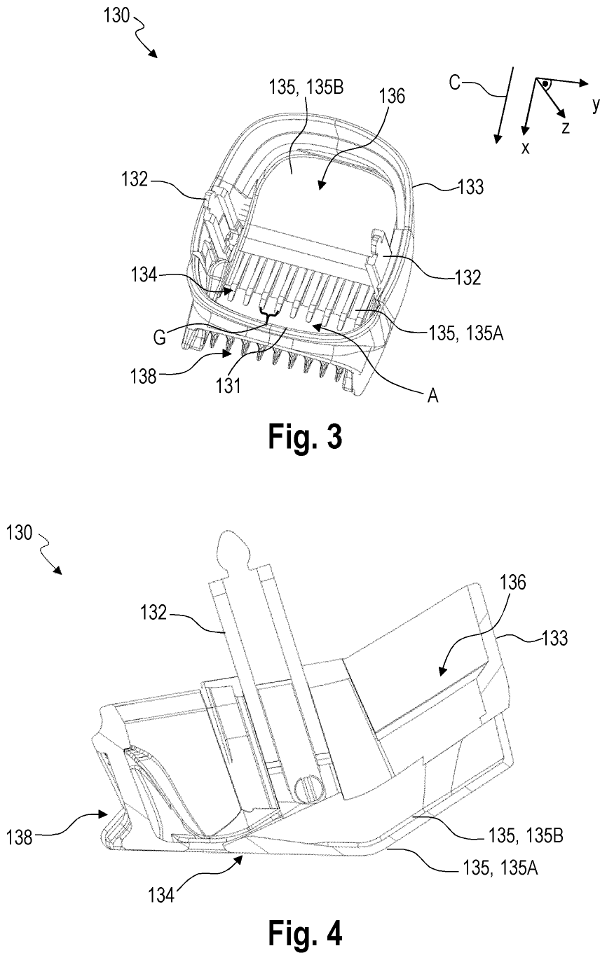

Further, as shown in FIG. 2, the comb attachment 130 further comprises a gap cover 135 that extends in sections from the sidewall 133 and that is adapted to cover the respective gap G between the individual first teeth 134. As can be seen in FIG. 2 (and even better in FIG. 3 or 5), the sidewall 133 and the gap cover 135 together form an enclosed space 136 that is adapted to at least temporarily collect cut hair debris during hair cutting and that is arranged, with respect to the cutting direction C or the arrow direction of the X-axis, respectively, at the rear of the comb attachment 130 and/or the frame portion 131. Thus, the sidewall 133, which overlaps with the housing 110 due to its height extension and at least partially circumferentially surrounds the cutting area A with the frame portion 131, and the gap cover 135 together form a rear collecting chamber for cut hair debris, which rear collecting chamber—as defined above—is arranged at the rear of the comb attachment 130 and/or the frame portion 131 with respect to the cutting direction C (which faces away from the arrowhead of the shown X-axis). As can be seen in FIG. 2, the gap cover 135 does not extend over the entire length of frame portion 131, but only over a section thereof (with respect to the cutting direction C), so that a respective free end of the individual first teeth 134 remains uncovered, or unfilled, etc. In other words, while the first teeth 134, from the rear of the frame portion 131, extend over a first length in the cutting direction C, the gap cover 135, from the rear of the frame portion 131, only extends over a second length in the cutting direction C, wherein the second length is shorter than the first length. Thus, at the point where the length extension of the gap cover 135 ends in the cutting direction C, an shovel-like entrance for collecting the cut hair debris in the rear collecting chamber (in particular the enclosed space 136) is formed. In some embodiments, the end of the gap cover 135 which is spaced from the rear of the frame portion 131 comprises a chamfer 137, so that clinging to the skin surface of the subject S may be improved. Further, in some embodiments, the chamfer 137 is at least substantially flush with a sliding surface of the first teeth 134, wherein the sliding surface may be understood as the respective surface of the individual first teeth 134 that faces away from the cutting area A and that is adapted to have contact with the skin surface of the subject S during hair cutting.

In some embodiments, the gap cover 135 may be provided by filling the respective gap G between the first teeth 134 by a filling material, filler, or by covering the respective gap G by a flat extending material, such as sheet, which material may be arranged on one or both sides of the first teeth 134, etc., so that the gap cover 135 may be integrally molded with the comb attachment 130 or at least some parts of the same. However, it is also conceivable that the gap cover 135 may be provided as a separate part, which may optionally be attached to an existing comb attachment, using, for example, a clip attachment means or the like. Likewise, it is conceivable that the gap cover 135 together with the sidewall 133 may be provided as a separate part, which may optionally be attached to an existing comb attachment.

Further referring to FIG. 2, the comb attachment 130 comprises a set of second teeth 138, which at least partially extending along the cutting area A from the frame portion 131. As it can be seen in FIG. 2, the second teeth 138 are approximately opposite to the first teeth 134, so that the second teeth 138 are directed towards the rear of the frame portion 131, wherein a free end of the second teeth 138 is spaced from a free end of the first teeth 134. In other words, while the first teeth 134 are hinged at, with respect to the cutting direction C, the rear of the frame portion 131, the second teeth are hinged at, with respect to the cutting direction C, the front of the frame portion 131. Thereby, the respective free ends of the first teeth 134 and second teeth 138 are spaced from each other. Thus, the individual teeth 134, 138 may move independently within limits of their elasticity, so that the cutting area A can better cling to the skin surface of the subject S.

FIG. 3 schematically shows a perspective bottom view of the comb attachment 130. So it basically shows an inside of the comb attachment 130. As it can be seen, the frame portion 131 exemplary has a substantially rectangular cross-section with rounded corners that encloses the cutting area A or the plane spanned by X-Y, respectively. As mentioned above, two attachment means 132 extend, with respect to the cutting direction C, on two opposing sides of and from the frame portion 131 in the along the Z-axis, which means towards the hair cutting appliance 100 (as shown in FIG. 1). Together with the attachment means 132, the sidewall 133 extends from the frame portion 131 in substantially the same direction, namely along the Z-axis, which also means towards the hair cutting appliance 100 (as shown in FIG. 1). As mentioned above, along the frame portion 131, the first teeth 134 extend in the cutting direction C, wherein the individual gaps of the first teeth are closed or covered, respectively, by the gap cover 135. Further, in this view according FIG. 3, the enclosed space 136 which is with respect to the cutting direction C arranged at the rear of the comb attachment 130 is clearly recognizable as the rear collection chamber.

In some embodiments, such as in the embodiment as shown in FIG. 3, the gap cover 135 comprises a first gap cover 135A and a second gap cover 135B. The first gap cover 135A may be regarded as the portion of the gap cover 135 that can be seen in FIG. 2. Accordingly, the first gap cover 135A is arranged on the outer side of the first teeth 134 and the second gap cover 135B is arranged at the inner side of the first teeth 134. As shown in FIG. 3, the second gap cover 135B may, with respect to the cutting direction C, extend over a third length that is shorter than the first length of the first teeth 134 and the second length of the first gap cover 135A. In this way, the first teeth 134, at least in the area of their free end, may be movable with respect to the second gap cover 135B. The first teeth 134 may be arranged or sandwiched between the first gap cover 135A and the second gap cover 135B, wherein one or both gap covers 135A, 135B may comprise a number of recesses, such as grooves, in which the individual first teeth 134 are disposed. As further shown in FIG. 3, the second gap cover 135B may have a chamfer, so as to further facilitate shoveling the cut hair debris towards the enclosed space 136.

Further, in some embodiments, such as in the embodiment as shown in FIG. 3, the gap cover 135 may be provided sheet-like so as not only to fill the respective gap G between the individual first teeth 134, but to also span the first teeth 134. In this case, the gap cover 135 does not necessarily comprise the first and second gap cover 135A, 135B, but may consist of only one of them.

FIG. 4 schematically shows a perspective sectional view of the comb attachment 130. It can be seen that the attachment means 132 and the sidewall 133 extend in a common direction, namely in a direction along the Z-axis (as shown in FIG. 1 or FIG. 2). Further, the spatial extend of the enclosed space 136 or rear collection chamber, respectively, can be seen.

With reference to FIG. 5, which shows a sectional view of the hair cutting appliance 100 with the attached comb attachment 130 in the operating condition (such as shown in FIG. 1), the basically function of the same will now be explained in the following. On the left side, a portion of the subject S having a skin surface with hair growing out is shown. The hair cutting appliance 100 is guided along the cutting direction C (as indicated by a respective arrow) with the outer side of the comb attachment 130 being in contact with the skin surface of the subject S. Thereby, the second teeth 138 set up the hair to be cut towards the cutting element 121, in particular towards its cutting edge 122, so that the hair is cut, a part of the hair may remain depending on the adjustment of the comb attachment 130 and cut hair debris occurs. It is noted that the cutting edge 122 is arranged, with reference to the cutting direction C, in front of the entrance of the enclosed spaced 136, which entrance is formed by the end spaced away from rear part of the frame portion 131 (also with reference to the cutting direction C). In other words, in the cutting direction C, the collection chamber formed by the enclosed space 136 is arranged behind the cutting edge 122.

As it can be seen in FIG. 5, the sidewall 133 overlaps at least at the rear of the comb attachment 130 with the housing 110 of the hair cutting appliance 100, wherein as mentioned above the indication of the rear refers to the cutting direction C. For ease of illustration, in FIG. 5, the overlap is indicated by a curly bracket and is designated by the reference sign O. Since the first teeth 134 are closed or covered, respectively, by the gap cover 135, the cut hair debris is transported shovel-like into the enclosed spaced 136 that forms the rear collection chamber. Thus, due to the overlap of the sidewall 133 with the housing 110 of the hair cutting appliance 100 and the gap cover 135, the cut hair debris is prevented from falling down or spreading after cutting.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

All features can be combined to provide a synergetic effect that is more than the simple summation of the features.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

### LIST OF REFERENCE SIGNS

100 hair cutting appliance
110 housing
111 switching means
112 counter attachment means
120 cutting unit
121 cutting element
122 cutting edge
130 comb attachment
131 frame portion
132 attachment means
133 sidewall
134 set of first teeth
135 gap cover
136 enclosed space/rear collection chamber
137 chamfer
138 set of second teeth
A cutting area
G gap
O overlap
X axis corresponding to a cutting direction
Y axis corresponding to a width direction
Z axis corresponding to a longitudinal direction

1. A comb attachment for a hair cutting appliance, comprising:
a frame portion enclosing a cutting area that is adapted to at least partially receive a cutting unit of the hair cutting appliance,
an attachment means extending from the frame portion away from the cutting area, the attachment means having at least one attachment point adapted to attach the comb attachment to the hair cutting appliance,
a sidewall extending from the frame portion in a common direction with the attachment means,
a set of first teeth at least partially extending along the cutting area from the frame portion in a first teeth extending direction that at least partially corresponds to a cutting direction during hair cutting, the first teeth are spaced from each other in a teeth spacing direction that is perpendicular to the first teeth extending direction, thereby forming a respective gap between the individual first teeth,
a gap cover extending in sections from the sidewall and adapted to cover the respective gap of the first teeth the sidewall and the gap cover forming an enclosed space adapted to at least temporarily collect cut hair debris during hair cutting,
wherein the sidewall extends over a height that overlaps with the at least one attachment point of the attachment means, the at least one attachment point being arranged so that the sidewall overlaps with a section of the hair cutting appliance when the comb attachment is attached thereto via the attachment means, and
wherein the gap cover and the sidewall, with respect to the cutting direction, are arranged at a rear of the frame portion.

2. The comb attachment according to claim 1, wherein the sidewall encloses a plane lying in the cutting area such that the sidewall extends, with respect to the cutting direction, at least in sections along, at least one lateral side of the frame portion.

3. The comb attachment according to claim 1, wherein the gap cover comprises a first gap cover adapted to cover the respective gap, with respect to the cutting area, from a first a side of the first teeth and a second gap cover adapted to cover the respective gap, with respect to the cutting area, from a second side of the first teeth, the second side opposing the first side.

4. The comb attachment according to claim 1, wherein the first teeth have a free end which is spaced from the rear of the frame portion.

5. The comb attachment according to claim 1, wherein an end of the gap cover which is spaced from the rear of the frame portion comprises a chamfer.

6. The comb attachment according to claim 5, wherein the chamfer is at least substantially flush with a sliding surface of the first teeth the sliding surface facing away from the cutting area and adapted to have skin surface contact during hair cutting.

7. The comb attachment according to claim 1, wherein the first teeth, from the rear of the frame portion, extend over a first length and the gap cover, from the rear of the frame portion, extends over a second length shorter than the first length.

8. The comb attachment according to claim 1, wherein the attachment means comprises a plurality of attachment points, each of which is assigned to an individual attachment position with respect to the hair cutting appliance, and wherein the sidewall extends over a height that overlaps with each one of the plurality of attachment points and with a section of the hair cutting appliance when the comb attachment is attached thereto via the attachment means.

9. The comb attachment according to claim 1, further comprising a set of second teeth at least partially extending along the cutting area from the frame portion towards the rear of the frame portion, wherein a free end of the second teeth is spaced from a free end of the first teeth.

10. A hair cutting appliance, comprising:
a housing,
a cutting unit comprising at least one cutting element extending in a cutting direction, and
a comb attachment adapted to be attached to the housing, the comb attachment comprising:
a frame portion enclosing a cutting area that is adapted to at least partially receive a cutting unit of the hair cutting appliance,
an attachment means extending from the frame portion away from the cutting area, the attachment means having at least one attachment point adapted to attach the comb attachment to the hair cutting appliance,
a sidewall extending from the frame portion in a common direction with the attachment means,
a set of first teeth at least partially extending along the cutting area from the frame portion in a first teeth extending direction that at least partially corresponds to a cutting direction during hair cutting, the first teeth are spaced from each other in a teeth spacing direction that is perpendicular to the first teeth extending direction, thereby forming a respective gap between the individual first teeth,
a gap cover extending in sections from the sidewall and adapted to cover the respective gap of the first teeth the sidewall and the gap cover forming an enclosed space adapted to at least temporarily collect cut hair debris during hair cutting,
wherein the sidewall extends over a height that overlaps with the at least one attachment point of the attachment means, the at least one attachment point being arranged so that the sidewall overlaps with a section of the hair cutting appliance when the comb attachment is attached thereto via the attachment means, and
wherein the gap cover and the sidewall, with respect to the cutting direction, are arranged at a rear of the frame portion.

11. The hair cutting appliance according to claim 10, wherein the enclosed space, with respect to the cutting direction, is arranged behind a cutting edge of the cutting element.

12. The hair cutting appliance according to claim 10, wherein the gap cover of the comb attachment extends from the sidewall over a length shorter than a cutting element extending length in the cutting direction.

13. The hair cutting appliance according to claim 10, wherein the gap cover of the comb attachment at least in sections extends in parallel to the cutting element.

14. The hair cutting appliance according to claim 10, wherein the enclosed space is further enclosed by the housing and/or the cutting unit.

15. The hair cutting appliance according to claim 10, wherein the sidewall of the comb attachment overlaps with the housing when the comb attachment is attached thereto via the attachment means.
